(19) United States
(12) Patent Application Publication
(10) Pub. No.: US 2015/0199607 A1
(43) Pub. Date: Jul. 16, 2015

(54) INCREMENTAL REASONING BASED ON SCALABLE AND DYNAMICAL SEMANTIC DATA

(71) Applicant: Empire Technology Development LLC, Wilmington, DE (US)

(72) Inventor: Jun Fang, Shaanxi (CN)

(21) Appl. No.: 14/410,056

(22) PCT Filed: May 31, 2013
(86) PCT No.: PCT/CN2013/076575

§ 371 Date: Dec. 19, 2014

(51) Int. Cl. G06N 5/04

(52) U.S. Cl. CPC G06N 5/04

(57) ABSTRACT

Technologies are generally described for performing a reasoning task based on a set of semantic data. In some examples, a method and a system for process a scalable and dynamical set of semantic data are described. The method may include extracting, by an incremental reasoning system, a first set of relevant data from the set of semantic data based on the reasoning task. The method may include generating, by the incremental reasoning system, a first set of reasoning results by performing the reasoning task based on the first set of relevant data. The method may further include maintaining, by the incremental reasoning system, a relevance tree based on the first set of relevant data, wherein the incremental reasoning system is configured to extract a second set of relevant data from the set of semantic data based on the relevance tree and generate a second set of reasoning results based on the second set of relevant data.

### BACKGROUND

In semantic ubiquitous computing, a semantic data set may be scalable and dynamical because 1) the semantic data set may be collected from a great number of heterogeneous data sources, and 2) the semantic data set may include real-time data that are constantly changing. For reasoning with a scalable and dynamic semantic data set, conventional methods generally use an offline computation approach to process the entire semantic data set, which may require a significant amount of time and resources. However, these conventional methods are generally infeasible in the dynamical situations, since every change that affects the semantic data set may require the repeating of the offline computation based on the entire semantic data set.

### SUMMARY

According to at least some embodiments, a method for performing a reasoning task based on a set of semantic data may include extracting, by an incremental reasoning system, a first set of relevant data from the set of semantic data based on the reasoning task. The method may include generating, by the incremental reasoning system, a first set of reasoning results by performing the reasoning task based on the first set of relevant data. The method may further include maintaining, by the incremental reasoning system, a relevance tree based on the first set of relevant data, wherein the incremental reasoning system is configured to extract a second set of relevant data from the set of semantic data based on the relevance tree and generate a second set of reasoning results based on the second set of relevant data.

According to at least other embodiments, a method for performing a reasoning task based on a set of semantic data may include performing, by an incremental reasoning system, the reasoning task by incrementally extracting a corresponding set of relevant data from the set of semantic data, generating a corresponding set of reasoning results based on the corresponding set of relevant data, and maintaining a relevance tree based on the corresponding set of relevant data. The method may further include concurrent to the performing of the reasoning task, monitoring, by the incremental reasoning system, the set of semantic data for changes that may affect the corresponding set of reasoning results.

According to at least other embodiments, a system for performing a reasoning task based on a set of semantic data may include a scalable data processing module configured to extract a first set of relevant data from the set of semantic data based on the reasoning task, and construct a relevance tree based on the first set of relevant data. The system may include a reasoning module coupled with the scalable data processing module, wherein the reasoning module is configured to generate a first set of reasoning results by performing the reasoning task based on the first set of relevant data. The system may further include a dynamical data processing module configured to operate concurrently along with the scalable data processing module to monitor the set of semantic data for changes that may affect the first set of reasoning results.

According to at least other embodiments, a non-transitory machine-readable medium may have a set of instructions which, when executed by a processor, cause the processor to perform a method for performing a reasoning task based on a set of semantic data. The method may include extracting, by an incremental reasoning system, a first set of relevant data from the set of semantic data based on the reasoning task. The method may include generating, by the incremental reasoning system, a first set of reasoning results by performing the reasoning task based on the first set of relevant data. The method may further include maintaining, by the incremental reasoning system, a relevance tree based on the first set of relevant data, wherein the incremental reasoning system is configured to extract a second set of relevant data from the set of semantic data based on the relevance tree and generate a second set of reasoning results based on the second set of relevant data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are therefore not to be considered limiting of its scope, the disclosure will be described with additional specificity and detail through use of the accompanying drawings.

In the drawings:

FIG. 1 is a block diagram of an illustrative incremental reasoning system for incremental reasoning based on scalable and dynamical semantic data;

FIG. 2 is a block diagram illustrating certain details of the incremental reasoning system of FIG. 1;

FIG. 3 is a block diagram illustrating a process performed by the incremental reasoning system of FIG. 1, as well as a resolvable relevance tree;

FIG. 4 is a flowchart of an illustrative method for performing an incremental reasoning task based on a set of semantic data;

FIG. 5 is a flowchart of an illustrative method for concurrently processing a set of scalable and dynamical semantic data;

FIG. 6 is a block diagram of an illustrative computer program product implementing a method for incremental reasoning based on scalable and dynamical semantic data; and

FIG. 7 is a block diagram of an illustrative computing device which may be used to perform incremental reasoning based on salable and dynamical semantic data, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is generally drawn, inter alia, to technologies including methods, apparatus, systems, devices, and computer program products related to the incremental reasoning based on scalable and dynamical semantic data, The term “incremental reasoning” may broadly refer to a process which performs multiple iterations of a reasoning task based on a set of scalable and dynamical semantic data. Each iteration of the reasoning task, which may be referred to as one “iteration of reasoning”, may include extracting a subset of relevant data from the set of scalable and dynamical semantic data, and generating a subset of reasoning results based on the subset of relevant data. Further, the subset of relevant data extracted in one iteration of reasoning may be used for extracting, in a subsequent iteration of reasoning, an additional subset of relevant data from the set of scalable and dynamical semantic data. The additional subset of relevant data may be used to generate additional subset of reasoning results. Therefore, rather than processing the entire set of scalable and dynamical semantic data before generating reasoning results, an incremental reasoning system may be configured to incrementally generate subsets of reasoning results during the multiple iterations of reasoning. Further, the incremental reasoning system may be configured to detect the changes in the set of scalable and dynamical semantic data which may affect the generated reasoning results, and update the reasoning results accordingly.

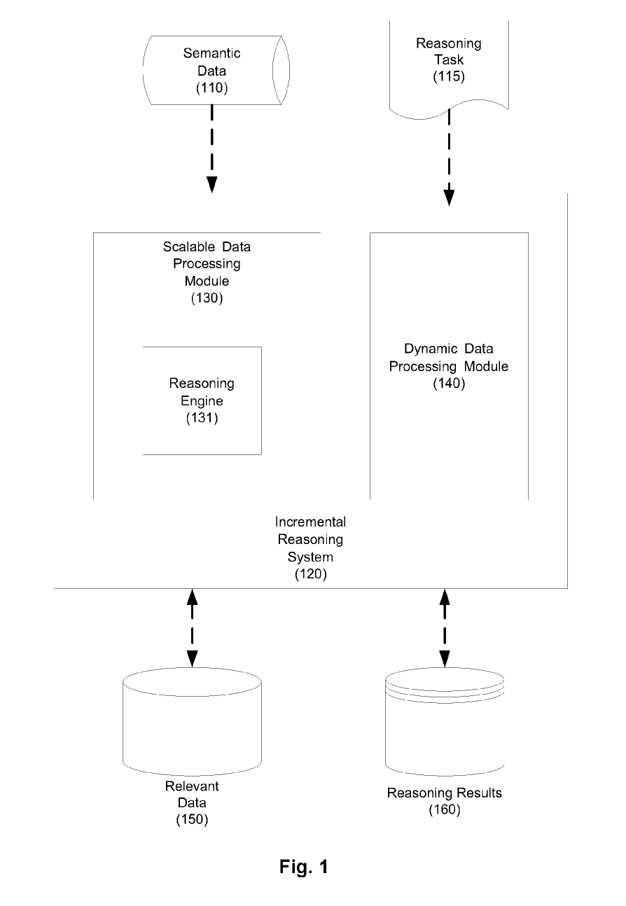

FIG. 1 is a block diagram of an illustrative incremental reasoning system 120 for incremental reasoning based on scalable and dynamical semantic data, arranged in accordance with at least some embodiments described herein. As depicted, the incremental reasoning system 120 may be configured to perform a reasoning task 115 in order to generate reasoning results 160 from the semantic data 110. The incremental reasoning system 120 may be configured with, among other components, a scalable data processing module 130 and a dynamical data processing module 140. The scalable data processing module 130 may be further configured with a reasoning engine 131.

In some embodiments, the semantic data 110 may contain a set of scalable and/or dynamical semantic information obtained from one or more data sources (e.g., Internet data retrieved via a search engine). As used herein, “semantic information” may refer to meaningful information which can be extracted and interpreted without human intervention. The semantic data 110 may be scalable, as the amount of data contained therein may be very large and increase exponentially in or over time. The semantic data 110 may also be dynamical, as the data contained therein may be changing (e.g., being added, updated, and/or deleted) regularly. Further, the semantic data 110 may contain an “ontology” having categories and domains of knowledge and information, and may be modeled or analyzed for their inner structures, hidden relationships, and/or implied meanings.

In some embodiments, the scalable data processing module 130 of the incremental reasoning system 120 may be configured to perform multiple iterations of reasoning by incremental processing of the semantic data 110 and incremental generating of multiple sets of reasoning results 160. Specifically, in a first iteration of reasoning, the scalable data processing module 130 may be configured to extract a first set of relevant data 150 from the semantic data 110 for or as being relevant to the reasoning task 115. Based on the first set of relevant data 150, the reasoning engine 131 may be configured to generate a first set of reasoning results 160 for the reasoning task 115.

In a second or subsequent iteration of reasoning, the scalable data processing module 130 may be configured to extract a second or subsequent set of relevant data 150 from the semantic data 110 as being relevant to the first set of relevant data 150. Afterward, the reasoning engine 131 may generate a second or subsequent set of reasoning results 160 based on the second or subsequent set of relevant data 150. Thus, by performing multiple iterations of reasoning, the incremental reasoning system 120 may extract more and more (i.e., additional) sets of relevant data 150 from the semantic data 110 and generate more and more (i.e., additional) sets of reasoning results 160. As a result, the incremental reasoning system 120 may be able to handle the semantic data 150 that is scalable without first processing the entire semantic data 110. Additional details regarding the scalable data processing module 130 are further described below.

In some embodiments, concurrent to the performing of the above iterations of reasoning by the scalable data processing module 130, the dynamical data processing module 140 of the incremental reasoning system 120 may be configured to monitor changes to the portions or parts of semantic data 110 that have been processed by the scalable data processing module 130. Upon detecting a change in the processed semantic data 110, the dynamical data processing module 140 may make appropriate updates to the portions or parts of the reasoning results 160 that may be affected by the change. Afterward, the scalable data processing module 130 may perform another iteration of reasoning to generate up-to-date reasoning results 160. Thus, the incremental reasoning system 120 may be able to handle the semantic data 110 that is dynamical, and generate reasoning results 160 that take the dynamical changes into consideration. Additional details regarding the dynamical data processing module 140 are further described below.

In some embodiments, the reasoning engine 131 may be configured to receive as inputs a set of relevant data 150 and a reasoning task 115, perform knowledge-based reasoning operations based on the set of relevant data 150, and generate a set of reasoning results 160 for the reasoning task 115. By way of example, the reasoning tasking 115 may request the reasoning engine 131 to perform a satisfiability (e.g., consistency) check, an instance check, and/or a subsumption check on the set of relevant data 150. The reasoning engine 131 may also be configured to perform deductive reasoning, inductive reasoning, and/or abductive reasoning on the set of relevant data 150, and utilize formal and/or informal logical operations to perform the reasoning task 115. The generated reasoning results 160 may include conclusions such as whether two statements are consistent with each other, whether one statement may be considered a subsumption of the other, or whether a statement may be true for a specific subject. The reasoning results 160 may also include answers to the reasoning task 115.

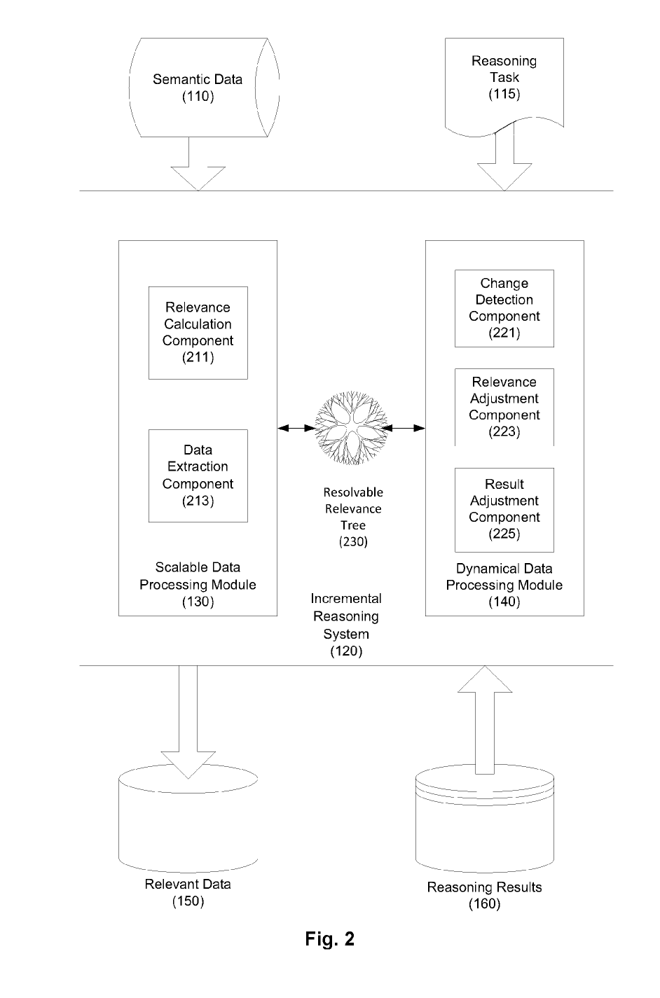

FIG. 2 is a block diagram illustrating certain details of the incremental reasoning system 120 of FIG. 1, arranged in accordance with at least some embodiments described herein. Those components in FIG. 2 that are labeled identically to components of FIG. 1 will not be described again for the purposes of clarity. The scalable data processing module 130 may be configured with or include, among other logic components, a relevance calculation component 211 and a data extraction component 213. The dynamical data processing module 140 may be configured with or include, among other logic components, a change detection component 221, a relevance adjustment component 223, and a result adjustment component 225. Further, a resolvable relevance tree 230 may be maintained and utilized by the scalable data processing module 130 and the dynamical data processing module 140 in performing their respective operations.

In some embodiments, the relevance calculation component 211 may be configured to perform relevance calculation to determine a logical semantic distance between two pieces of data. The data extraction component 213 may be configured to extract relevant data 150 from the semantic data 110 and create/update the resolvable relevance tree 230 under the guidance of the relevance calculation component 211. The change detection component 221 may be configured to detect changes made to the semantic data 110. Based on the detected changes, the relevance adjustment component 223 may be configured to update the resolvable relevance tree 230, and the result adjustment component 225 may be configured to update the reasoning results 160.

As described above, the scalable data processing module 130 may be configured to perform multiple iterations of reasoning in order to generate the reasoning results 160. In each of the multiple iterations of reasoning, the scalable data processing module 130 may utilize the data extraction component 213 to extract the relevant data 150 from the semantic data 110 based on “relevance”. A first piece of data may have relevance with a second piece of data when a “logical semantic distance” between these two pieces of data is smaller than a predetermined threshold. In some embodiments, the relevance calculation component 211 may utilize a resolvable relevance calculation to determine the logical semantic distance between the two pieces of data. Thus, when the relevance calculation component 211 determines that a piece of data selected from the semantic data 110 may have “direct relevance” or “indirect relevance” with the reasoning task 115, the piece of data may be included as a part of the extracted relevant data 150.

In some embodiments, during a first or initial iteration of reasoning, the data extraction component 213 may extract a first set of relevant data 150 from the semantic data 110 for having relevance with the reasoning task 115 (or a negation form of the reasoning task 115). Based on the first set of relevant data 150, a reasoning engine (not shown in FIG. 2, similar to the reason engine 131 of FIG. 1) may then generate a first set of reasoning results 160. In the meantime, the data extraction component 213 may construct the resolvable relevance tree 230 based on the first set of relevant data 150.

In some embodiments, the “resolvable relevance tree” may be a data structure for storing relevance relationships among the relevant data 150 and the reasoning task 115. In the resolvable relevance tree 230, the root node may be associated with the reasoning task 115, and each of the child nodes may be associated with a corresponding piece of the relevant data 150. Further, if a first piece of relevant data may have a direct or indirect relevance with a second piece of relevant data, then two child nodes corresponding to these two pieces of relevant data may have a parent-child relationship and/or belong to a specific branch of the resolvable relevance tree 230.

During the first iteration of reasoning, as each piece of data in the first set of relevant data 150 may have direct relevance with the reasoning task 115, the data extraction component 213 may construct a first node for a first piece of data in the first set of relevant data 150, place the first node as the root node's child in the resolvable relevance tree 230, and associate the first piece of data with the first node. The data extraction component 213 may select a second piece of data and construct a second node in the resolvable relevance tree 230 as illustrated above, until every piece of data in the first set of relevant data 150 is processed. After the first set of relevant data 150 are processed, the resolvable relevance tree 230 may contain a first layer of nodes associated with the first set of relevant data 150, and the first layer of nodes may be child nodes of the root node. And the scalable data processing module may use the constructed resolvable relevance tree 230 to record and track the subsequent iterations of reasoning.

In some embodiments, the scalable data processing module 130 may perform a second (or a subsequent) iteration of reasoning based on the resolvable relevance tree 230 that is constructed in the first (or the previous) iteration of reasoning. In the second iteration, the data extraction component 213 may extract a second set of relevant data 150 from the semantic data 110 for having relevance with the leaf nodes of the resolvable relevance tree 230. During the extraction, the data extraction component 213 may select a leaf node from the resolvable relevance tree 230 and select a piece of data from the semantic data 110. When the relevance calculation component 211 determines that the piece of data has relevance with the associated data in the leaf node, the data extraction component 213 may include the piece of data in the second set of relevant data 150. Afterward, the data extraction component 213 may construct a specific node for the piece of data, place the specific node as the leaf node's child node in the resolvable relevance tree 230, and associate the piece of data with the specific node.

In some embodiments, once processed all leaf nodes of the resolvable relevance tree 230, the data extraction component 213 may obtain a second set of relevant data 150 from the semantic data 110. Further, the data extraction component 213 may construct a second layer of nodes for the resolvable relevance tree 230 based on the second set of relevant data 150. Particularly, each node in the second layer of nodes may be a leaf node that has one or more parent-child relationships with nodes in the first layer of nodes. For a subsequent iteration of reasoning, the data extraction component 213 may add an additional layer of nodes to the resolvable relevance tree 230. Thus, the leaf nodes in the resolvable relevance tree 230, which are generated by a previous iteration of reasoning, may be used to guide the extracting of relevant data in a subsequent iteration of reasoning.

In some embodiments, the second set of relevant data 150 may be different from the first set of relevant data 150 generated by the previous iteration of reasoning. Afterward, the reasoning engine may generate a second set of reasoning results 160 based on the second set of relevant data 150 and/or the first set of relevant data 150. Thus, the second set of reasoning results 160 may include or compliment the first set of reasoning results 160, and the scalable data processing module 130 may repeat the above iteration of reasoning in one or more times to generate additional reasoning results 160.

In some embodiments, the resolvable relevance tree 230 may be configured to store a set of “source relationships” between a particular set of relevant data 150 and the semantic data 110, and a set of “result relationships” between the set of relevant data 150 and the reasoning results 160. Specifically, since during each iteration of reasoning, the data extraction component 213 may keep track of the source location a particular piece of relevant data extracted from the semantic data 110, as well as the particular reasoning result 160 generated based on the particular piece of relevant data, these information may be used to set up the set of source relationships and the set of result relationships.

In some embodiments, the data extraction component 213 may save as a source relationship the association between a particular piece of relevant data and its source location in the semantic data 110, and store the source relationship in a node of the resolvable relevance tree 230 that is associated with the particular piece of relevant data. Further, the data extraction component 213 may save as a result relationship the association between the particular piece of relevant data and a particular reasoning result, and store the result relationship in the same node of the resolvable relevance tree 230 that is associated with the particular piece of relevant data. Afterward, the resolvable relevance tree 230 may be used for the monitoring changes made to the semantic data 110 and the updating of the reasoning results 160 that are affected by the changes.

In some embodiments, concurrent to the processing of the semantic data 110 by the scalable data processing module 130, the dynamical data processing module 140 may be configured to detect changes in the semantic data 110, and update the reasoning results 160 based on the detected changes. In other words, the scalable data processing module 130 and the dynamical data processing module 140 may be operating in parallel. The dynamical data processing module 140 may utilize the change detection component 221 to detect/identify changes in the semantic data 110 that may affect the reasoning results 160. Upon detection of these changes, the dynamical data processing module 140 may instruct the relevance adjustment component 223 to modify the resolvable relevance tree 230, and instruct the result adjustment component 225 to adjust the generated reasoning results 160, according to the changes identified by the change detection component 221.

In some embodiments, the change detection component 221 may utilize the resolvable relevance tree 230 to identify any changes that occurred since the last iteration of the reasoning. Since the resolvable relevance tree 230 store source relationships and result relationships in nodes that are associated with relevant data 150, the change detection component 221 may traverse the nodes in the resolvable relevance tree 230 and obtain the source locations from the nodes. The source locations may be used to identify those of the semantic data 110 that have contributed in the generating of the reasoning results 160. Afterward, the change detection component 221 may monitor these source locations for any updates (e.g., creation, modification, and/or deletion) that may affect the semantic data 110.

In some embodiments, once the change detection component 221 detects that an update occurred at a specific source location, the dynamical data processing module 140 may identify the particular node that has a source relationship with the specific source location, and instruct the relevance adjustment component 223 to adjust the node in the resolvable relevance tree 230. For example, if the update is a deletion, then the relevance adjustment component 223 may remove specific node and/or the child nodes of the specific node from the resolvable relevance tree 230. If the update is an addition, then the relevance adjustment component 223 may create a new node as a leaf node of the specific node. The new node may include the newly added data in the source location. During the next iteration of reasoning, the scalable data processing module 130 may select the new leaf node in the resolvable relevance tree 230, and generate relevant data 150 based on the newly added information associated with the new leaf node. Further, the relevance adjustment component 223 may treat a modification update as a deletion and an addition.

In some embodiments, the result adjustment component 225 may adjust the reasoning results 160 based on the change identified by the change detection component 221. For example, for the specific node identified by the relevance adjustment component 223, the result adjustment component 225 may utilize the result relationship stored in the specific node to identify a portion of the reasoning results 160 that are generated based on the specific node. Afterward, if the update is a modification or deletion, the result adjustment component 225 may remove the portion of the reasoning results 160 as being no longer valid. If the update is an addition, then the result adjustment component 225 may not need to adjust the reasoning results 160, as the scalable data processing module 130 may subsequently generate the corresponding reasoning results 160 for the newly added information. Thus, by utilizing the resolvable relevance tree 230, the dynamical data processing module 140 may continuously detecting the changes in the semantic data 110, and keeping the reasoning results 160 up-to-date.

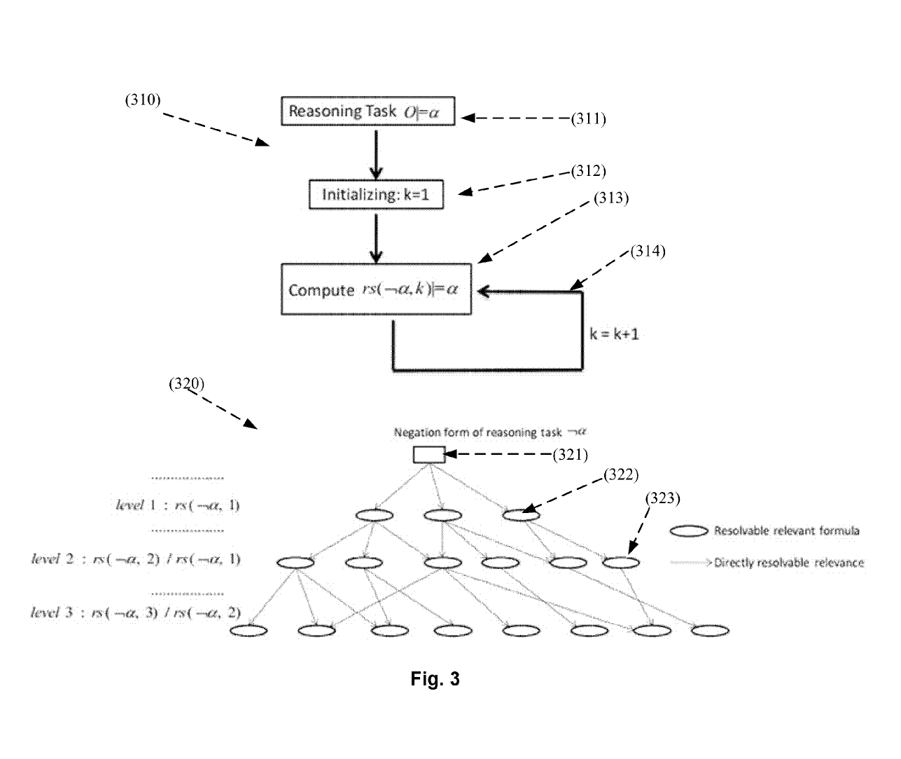

FIG. 3 is a block diagram illustrating a process 310 performed by the incremental reasoning system 120 of FIG. 1, as well as a resolvable relevance tree 320, arranged in accordance with at least some embodiments described herein. Using description logic notions, the semantic data 110 of FIG. 1 may be referred to as an “ontology” or a “semantic data set”, and the relevant data 150 of FIG. 1 may be referred to as a “formula.” Thus, given an ontology O and a reasoning task T, the scalable data processing module 130 of FIG. 1 may initiate the process 310 to perform the reasoning task T based on the ontology O, and generate the resolvable relevance tree 320 during the multiple iterations of reasoning. Further, the dynamical data processing module 140 of FIG. 1 may initiate a parallel process to deal with dynamical changes in the ontology O based on the resolvable relevance tree 320.

Referring back to FIG. 3, block 311 may define the reasoning task T using a description logic notion. At block 312, the scalable data processing module 130 may perform a first iteration of reasoning and construct the resolvable relevance tree 320. In some embodiments, the resolvable relevance tree 320 may be constructed based on a resolvable relevance function. In a description logic notion, when an ontology O entails a formula α, then O∪{ [symbol] α} may be inconsistent. Thus, the formulas which are resolvable with α may “conclude the inconsistency” in a reasoning process. In other words, the formulas that are resolvable with formula α may be deemed relevant with the formula α, as they may have the effect on the reasoning process. Hence, the resolvable relevance function, which may be used by the relevance calculation component 211 of FIG. 2, may be based on the above solution approach.

In the description logic definition, two standard formulas α and β may have “directly resolvable relevance” if and only if there exists an atomic formula A which exists in one of the two standard formulas α and β, and an atomic formula [symbol] A which exists in another one of the two standard formulas α and β. Then, a resolvable relevance function res(α,β) may be the resolvent of α and β with respect to A. The resolvable relevance may be used to show one or more semantic relations between the two standard formulas α and β. Such semantic relations may include simple relations such as “in the same place”, “at the same time”, and/or “belongs to.” The resolvable relevance may further show complex relations such as metaphor. Hence, in each step, the semantically relevant formulas may be selected from the semantic data based on the resolvable relevance.

Further, the transformation of any formula to a standard formula may be accomplished by iteratively apply the following four rules, until no more rules may be applied:

[symbol]

∃xP(x)=∀x [symbol] P(x) 1)

[symbol]

∀xP(x)=∃x [symbol] P(x) 2)

[symbol]

(P̂Q)= [symbol] Pv [symbol] Q 3)

[symbol]

(PvQ)= [symbol] P̂ [symbol] Q 3)

Likewise, two standard formulas α and α′ may be k-step indirectly resolvable relevant with respect to a formula set S if and only if there exists formulas β₁, . . . , βₖ, α and β₁, res(α,β₁) and β₂, . . . res( . . . (res(res(α,β₁),β₂), . . . ), βₖ) and a are all directly resolvable relevant. Thus, given a formula φ, the resolvable relevance function rs(φ,k) may be calculated as the following, based on formulas which are from 1 to k−1 steps indirectly relevant with φ:

rs(φ,0)=Ø

rs(φ,1)={ψ|ψ and φ are directly resolvable}

rs(φ,k)=rs(φ,k−1)∪{ψ|ψ and φ are k-step indirectly resolvable}, when k≧1

rs(φ,k)=rs(φ,k−1)∪{ψ|ψ and φ are directly resolvable,

φε resolvents of rs(φ,k−1)}, when k≧1

In other words, starting by using formula [symbol] α in the first iteration of reasoning (312), the relevance calculation component 211 may perform the k-th iteration of reasoning to generate the resolvable relevance values rs(φ,k) based on the resolvable relevance value rs(φ,k−1) generated in the k−1 iteration of reasoning (313 and 314). As shown in the resolvable relevance tree 320, each iteration of reasoning may generate one level of nodes, with the root node 321 representing a negation form of the reasoning task ( [symbol] α).

Thus, during the first iteration of reasoning, the scalable data processing module 130 may identify a first set of relevant data which have direct resolvable relevance with the negation form of the reasoning task in the root node 321, and construct one or more level-1 nodes (e.g., node 322) as child nodes of the root node 321. During a second iteration of reasoning, the scalable data processing module 130 may pick each of the level-1 nodes, and identify a corresponding second set of relevant data, similar to the identification of the first set of relevant data based on the root node 321. Afterward, the scalable data processing module 130 may construct one or more level-2 nodes (e.g., node 323) based on the one or more second set of relevant data, and connect these level-2 nodes as child nodes of the level-1 nodes. Specifically, if a level-2 node has a directly resolvable relevance with a second level 1 node, then the level-2 node may be added as the second level-1 node's child node. Once the level-2 nodes are added to the resolvable relevance tree 320, they may be deemed to have indirectly resolvable relevance with the root node 321.

Thus, the resolvable relevance tree 320 may be used to record the multiple iterations of reasoning. The selection of additional relevant data may be based on the leave nodes of the resolvable relevance tree 320. Each path in the resolvable relevance tree 320 may correspond to a reasoning result. Further, the dynamic data processing module 140 may utilize the nodes and branches in the resolvable relevance tree 320 for detecting dynamical changes in the semantic data source, and locate the reasoning results that are associated with these nodes and branches.

For instance, based on a reasoning task to “evaluate the financial prospect of a company”, the scalable data processing module 130 may identify a first set of relevant data including “financial reporting of the company”, “market share of the company”, and/or “exchange-rate situation”, each of which may be deemed having resolvable relevance with the reasoning task. The scalable data processing module 130 may then build a resolvable relevance tree 320 having three level-1 nodes corresponding to the first set of relevant data. Based on the first set of relevant data, the reasoning engine may generate some preliminary reasoning results to show the company's financial prospect.

When the first set of relevant data may not be sufficient to provide accurate reasoning results, the scalable data processing module 130 may identify a second set of relevant data based on the first set of relevant data. The second set of relevant data may include “situations of the competitors” and/or “related national economic policy.” The scalable data processing module 130 may then construct two level-2 nodes corresponding to the second set of relevant data for the resolvable relevance tree 320. For example, the leaf node for the “situations of the competitors” may be a child node of the “financial reporting of the company” node and the “market share of the company” node. And the leaf node for the “related national economic policy” may be a child node of the “exchange-rate situation” node. Afterward, the reasoning engine may generate a second set of reasoning results, which may be more accurate than the first set of reasoning results, based on the second set of relevant data. Further, when the semantic data related to the “exchange-rate situation” is changed, the dynamical data processing module 140 may remove the node for the “exchange-rate situation” and its child nodes, as well as the reasoning results that are associated with the removed nodes. During a subsequent iteration of reasoning, the scalable data processing module 130 may update the resolvable relevance tree 320 and generate new reasoning results that correspond to the updated semantic data related to the “exchange-rate situation.”

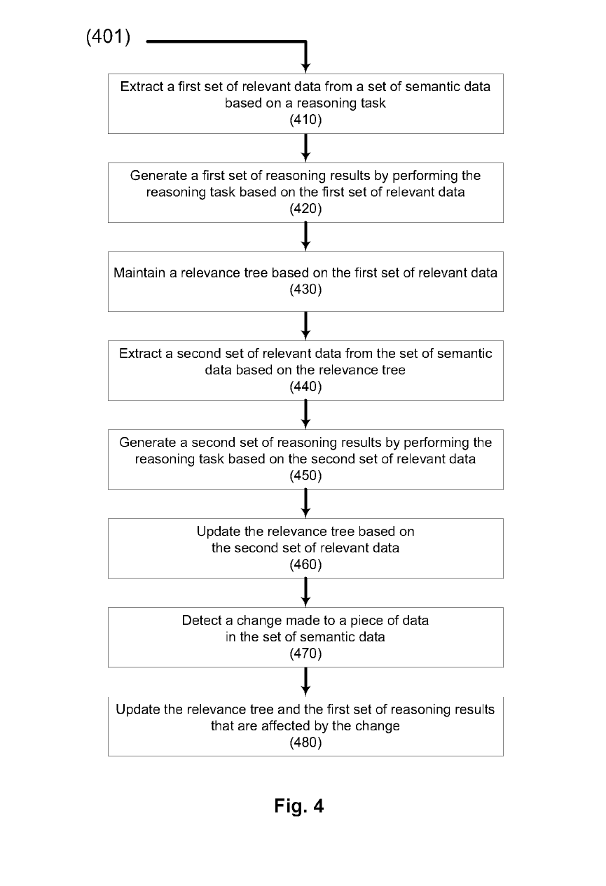

FIG. 4 is a flowchart of an illustrative method 401 for performing an incremental reasoning task based on a set of semantic data, arranged in accordance with at least some embodiments described herein. Method 401 includes blocks 410, 420, 430, 440, 450, 460, 470, and 480. Although the blocks in FIG. 4 and other figures in the present disclosure are illustrated in a sequential order, these blocks may also be performed in parallel, and/or in a different order than those described herein. Also, the various blocks may be combined into fewer blocks, divided into additional blocks, supplemented with additional blocks, and/or eliminated based upon the particular implementation.

Processing for method 401 may begin at block 410, “extract a first set of relevant data from a set of semantic data based on a reasoning task.” Block 410 may be followed by block 420, “generate a first set of reasoning results by performing the reasoning task based on the first set of relevant data.” Block 420 may be followed by block 430, “maintain a relevance tree based on the first set of relevant data” Block 430 may be followed by block 440, “extract a second set of relevant data from the set of semantic data based on the relevance tree.” Block 440 may be followed by block 450, “generate a second set of reasoning results by performing the reasoning task based on the second set of relevant data.” Block 450 may be followed by block 460, “update the relevance tree based on the second set of relevant data.” Block 460 may be followed by block 470, “detect a change made to a piece of data in the set of semantic data.” And block 470 may be followed by block 480, “update the relevance tree and the first set of reasoning results that are affected by the change.”

At block 410, an incremental reasoning system may be configured to perform a reasoning task on a set of semantic data using multiple iterations of reasoning. The incremental reasoning system may extract a first set of relevant data from the set of semantic data based on the reasoning task. In some embodiments, during a first iteration of reasoning, the incremental reasoning system may utilize a resolvable relevance function to extract the first set of relevant data from the set of semantic data for being relevant to the reasoning task.

At block 420, the incremental reasoning system may generate a first set of reasoning results by performing the reasoning task based on the first set of relevant data. The incremental reasoning system may maintain a relevance tree (e.g., a resolvable relevance tree) for the generating of the first set of reasoning results. Specifically, for each node in the relevance tree, the incremental reasoning system may perform the reasoning task to obtain a subset of reasoning results based on a corresponding set of relevant data that is associated with the node. Afterward, the incremental reasoning system may include the subset of reasoning results in the first set of reasoning results.

At block 430, the incremental reasoning system may maintain the relevance tree based on the first set of relevant data. Afterward, the incremental reasoning system may be configured to extract a second set of relevant data from the set of semantic data based on the relevance tree and generate a second set of reasoning results based on the second set of relevant data. In some embodiments, the incremental reasoning system may associate a root node of the relevance tree with the reasoning task, construct a first node as a child node of the root node, and associate the first node with the first set of relevant data. Further, the incremental reasoning system may store a set of source relationships between the first set of relevant data and the set of semantic data in the relevance tree; and store a set of result relationships between the first set of relevant data and the first set of reasoning results in the relevance tree.

At block 440, the incremental reasoning system may extract the second set of relevant data from the set of semantic data based on the relevance tree. Specifically, since this is a subsequent iteration of reasoning, the incremental reasoning system may utilize a resolvable relevance function to extract the second set of relevant data from the set of semantic data for being relevant to a leaf node of the relevance tree.

At block 450, the incremental reasoning system may generate a second set of reasoning results by performing the reasoning task based on the second set of relevant data.

At bock 460, the incremental reasoning system may update the relevance tree based on the second set of relevant data. Afterward, the incremental reasoning system may be configured to extract a third set of relevant data from the set of semantic data based on the updated relevance tree and generate a third set of reasoning results based on the third set of relevant data. In some embodiments, the incremental reasoning system may construct a second node as a child node of the first node in the relevance tree, and associate the second node with the second set of relevant data.

At block 470, the incremental reasoning system may detect a change made to a piece of data in the set of semantic data. In some embodiments, the incremental reasoning system may identify the piece of data from the set of semantic data for affecting the relevance tree and the first set of reasoning results.

At block 480, the incremental reasoning system may update the relevance tree and the first set of reasoning results that are affected by the change. Further, the incremental reasoning system may be configured to generate a third set of reasoning results based on the updated relevant tree. In some embodiments, the incremental reasoning system may identify a first node in the relevance tree for having the source relationship with the piece of data.

In some embodiments, upon a determination that the change is a modification or a deletion, the incremental reasoning system may remove the first node and its child nodes from the relevance tree, and remove a subset of reasoning results from the first set of reasoning results, wherein the subset of reasoning results are identified for having result relationships with the first node and its child nodes. Upon a determination that the change is a modification, the incremental reasoning system may add a second node in replacement of the first node in the relevance tree. Afterward, the incremental reasoning system may be configured to utilize the second node for generating the third set of reasoning results based on the updated relevant tree.

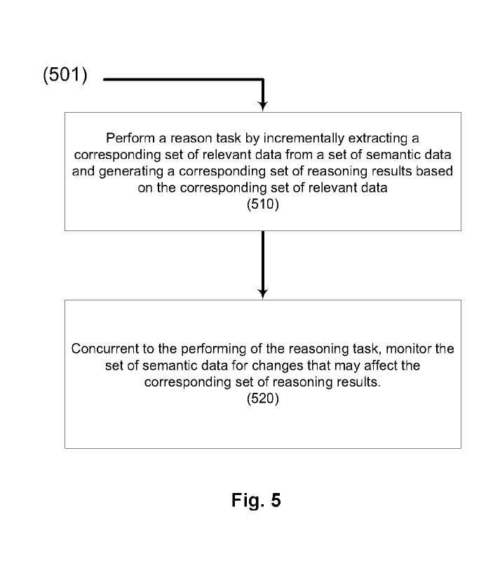

FIG. 5 is a flowchart of an illustrative method 501 for concurrently processing a set of scalable and dynamical semantic data, arranged in accordance with at least some embodiments described herein. Method 501 includes blocks 510 and 520. Processing for method 501 may begin at block 510, “perform a reasoning task by incrementally extracting a corresponding set of relevant data from a set of semantic data and generate a corresponding set of reasoning results based on the corresponding set of relevant data.” Block 510 may be followed by block 520, “concurrent to the performing of the reasoning task, monitor the set of semantic data for changes that may affect the corresponding set of reasoning results.”

At block 510, an incremental reasoning system may perform a reasoning task by incrementally extracting a corresponding set of relevant data from a set of semantic data. The incremental reasoning system may generate a corresponding set of reasoning results based on the corresponding set of relevant data, and maintain a relevance tree based on the corresponding set of relevant data. In some embodiments, in a first iteration of reasoning, the incremental reasoning system may extract the corresponding set of relevant data from the set of semantic data for being relevant to the reasoning task. In a second iteration subsequent to the first iteration, the incremental reasoning system may extract the corresponding set of relevant data for the set of semantic data for being relevant to a leaf node of the relevance tree, and update the relevance tree based on the corresponding set of relevant data.

Further, when maintaining the relevance tree, the incremental reasoning system may store a set of source relationships between the corresponding set of relevant data and the set of semantic data in the relevance tree; and store a set of result relationships between the corresponding set of relevant data and the corresponding set of reasoning results in the relevance tree.

At block 520, the incremental reasoning system may, concurrent to the performing of the reasoning task, monitor the set of semantic data for changes that may affect the corresponding set of reasoning results. The incremental reasoning system may detect a change made to a piece of data in the set of semantic data. Specifically, the incremental reasoning system may identify the piece of data from the set of semantic data based on the set of source relationships. The incremental reasoning system may further update the relevance tree and the corresponding set of reasoning results that are affected by the change based on the set of result relationships.

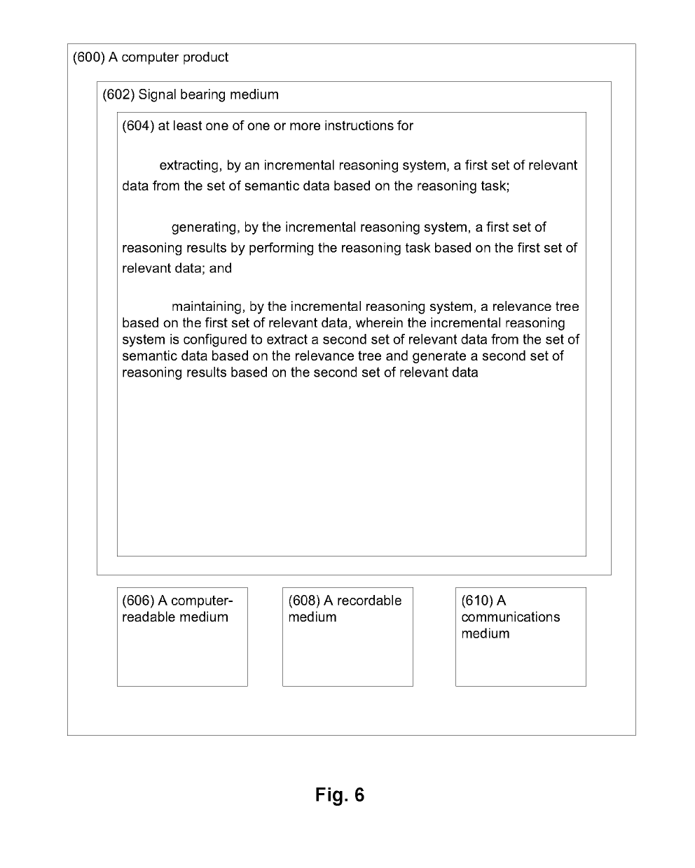

FIG. 6 is a block diagram of an illustrative computer program product 600 implementing a method for incremental reasoning based on scalable and dynamical semantic data, arranged in accordance with at least some embodiments described herein. Computer program product 600 may include a signal bearing medium 602. Signal bearing medium 602 may include one or more sets of non-transitory machine-executable instructions 604 that, when executed by, for example, a processor, may provide the functionality described above. Thus, for example, referring to FIG. 1, the incremental reasoning system 120 may undertake one or more of the operations shown in at least FIG. 4 in response to the instructions 604.

In some implementations, signal bearing medium 602 may encompass a non-transitory computer readable medium 606, such as, but not limited to, a hard disk drive, a Compact Disc (CD), a Digital Versatile Disk (DVD), a digital tape, memory, etc. In some implementations, signal bearing medium 602 may encompass a recordable medium 608, such as, but not limited to, memory, read/write (R/W) CDs, R/W DVDs, etc. In some implementations, signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, referring to FIG. 1, computer program product 600 may be wirelessly conveyed to the incremental reasoning system 120 by signal bearing medium 602, where signal bearing medium 602 is conveyed by communications medium 610 (e.g., a wireless communications medium conforming with the IEEE 802.11 standard). Computer program product 600 may be recorded on non-transitory computer readable medium 606 or another similar recordable medium 608.

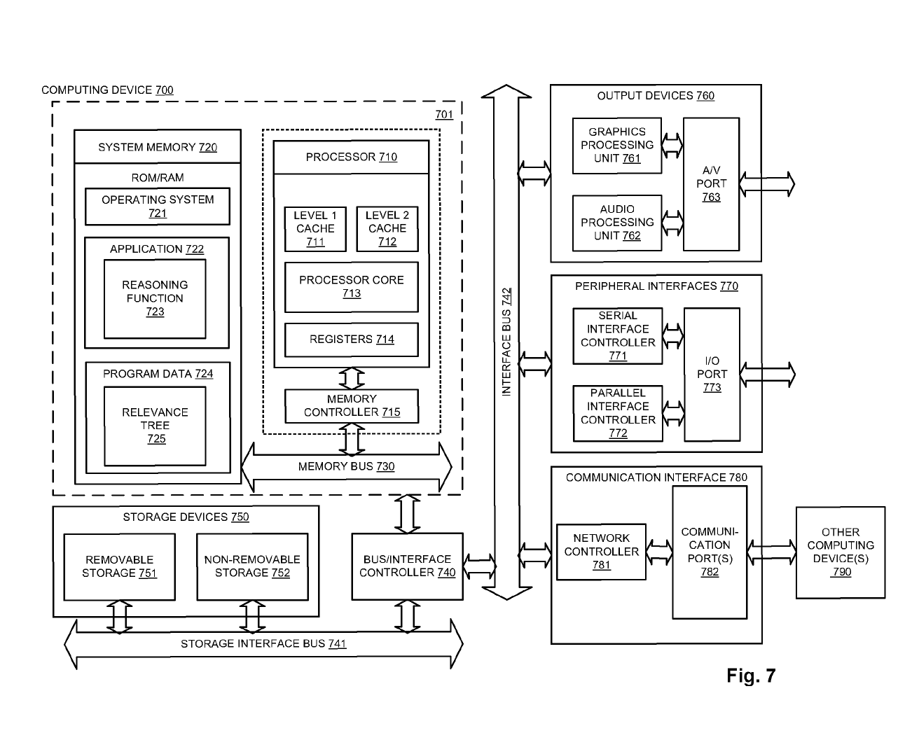

FIG. 7 is a block diagram of an illustrative computer device 700 which may be used to perform incremental reasoning based on scalable and dynamical semantic data, arranged in accordance with at least some embodiments described herein. In a basic configuration, computing device 700 typically includes one or more host processors 710 and a system memory 720. A memory bus 730 may be used for communicating between host processor 710 and system memory 720.

Depending on the particular configuration, host processor 710 may be of any type including but not limited to a microprocessor (μP), a microcontroller (μC), a digital signal processor (DSP), or any combination thereof. Host processor 704 may include one more levels of caching, such as a level one cache 711 and a level two cache 712, a processor core 713, and registers 714. An example processor core 713 may include an arithmetic logic unit (ALU), a floating point unit (FPU), a digital signal processing core (DSP Core), or any combination thereof. An example memory controller 715 may also be used with host processor 710, or in some implementations memory controller 715 may be an internal part of host processor 710.

Depending on the particular configuration, system memory 720 may be of any type including but not limited to volatile memory (such as RAM), non-volatile memory (such as ROM, flash memory, etc.), or any combination thereof. System memory 720 may include an operating system 721, one or more applications 722, and program data 724. Application 722 may include a reasoning function 723 that can be arranged to perform the functions as described herein, including those described with respect to at least the method 401 in FIG. 4. Program data 724 may include relevance tree 725 utilized by the reasoning function 723. In some embodiments, application 722 may be arranged to operate with program data 724 on operating system 721 such a method to perform a reasoning task based on a set of semantic data, as described herein. This described basic configuration 701 is illustrated in FIG. 7 by those components within the inner dashed line.

Computing device 700 may have additional features or functionality, and additional interfaces to facilitate communications between basic configuration 701 and any required devices and interfaces. For example, a bus/interface controller 740 may be used to facilitate communications between basic configuration 701 and one or more data storage devices 750 via a storage interface bus 741. Data storage devices 750 may be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 720, removable storage devices 751, and non-removable storage devices 752 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 742 for facilitating communication from various interface devices (e.g., output devices 760, peripheral interfaces 770, and communication devices 780) to basic configuration 701 via bus/interface controller 740. Example output devices 760 include a graphics processing unit 761 and an audio processing unit 762, which may be configured to communicate to various external devices such as a display or speakers via one or more A/V ports 763. Example peripheral interfaces 770 include a serial interface controller 771 or a parallel interface controller 772, which may be configured to communicate with external devices such as input devices (e.g., keyboard, mouse, pen, voice input device, touch input device, etc.) or other peripheral devices (e.g., printer, scanner, etc.) via one or more I/O ports 773. An example communication device 780 includes a network controller 781, which may be arranged to facilitate communications with one or more other computing devices 790 over a network communication link via one or more communication ports 782. In some implementations, computing device 700 includes a multi-core processor, which may communicate with the host processor 710 through the interface bus 742.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the particular vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In some embodiments, several portions of the subject matter described herein may be implemented via Application Specific Integrated Circuits (ASICs), Field Programmable Gate Arrays (FPGAs), digital signal processors (DSPs), or other integrated formats.

Some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware is possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link and/or channel, a wireless communication link and/or channel, etc.).

The devices and/or processes are described in the manner set forth herein, and thereafter engineering practices may be used to integrate such described devices and/or processes into data processing systems. That is, at least a portion of the devices and/or processes described herein can be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The subject matter described herein sometimes illustrates different components contained within, or connected with, different other components. Such depicted architectures are merely examples and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, the terms may be translated from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense generally understood for the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense generally understood for the convention (e.g., “a system having at least one of A, B, or C” would include but not be limited to systems that have A alone, B alone, C alone, A and B together, A and C together, B and C together, and/or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method for performing a reasoning task based on a set of semantic data, the method comprising:
extracting, by an incremental reasoning system, a first set of relevant data from the set of semantic data based on the reasoning task;
generating, by the incremental reasoning system, a first set of reasoning results by performing the reasoning task based on the first set of relevant data; and
maintaining, by the incremental reasoning system, a relevance tree based on the first set of relevant data, wherein the incremental reasoning system is configured to extract a second set of relevant data from the set of semantic data based on the relevance tree and generate a second set of reasoning results based on the second set of relevant data.

2. The method of claim 1, further comprising:
extracting, by the incremental reasoning system, the second set of relevant data from the set of semantic data based on the relevance tree;
generating, by the incremental reasoning system, a second set of reasoning results by performing the reasoning task based on the second set of relevant data; and
updating, by the incremental reasoning system, the relevance tree based on the second set of relevant data, wherein the incremental reasoning system is configured to extract a third set of relevant data from the set of semantic data based on the updated relevance tree and generate a third set of reasoning results based on the third set of relevant data.

3. The method of claim 1, wherein extracting the first set of relevant data comprises:
utilizing a resolvable relevance function to extract the first set of relevant data from the set of semantic data for being relevant to the reasoning task.

4. The method of claim 2, wherein extracting the second set of relevant data comprises:
utilizing a resolvable relevance function to extract the second set of relevant data from the set of semantic data for being relevant to a leaf node of the relevance tree.

5. The method of claim 1, wherein generating the first set of results comprises:
for each node in the relevance tree,
performing the reasoning task to obtain a subset of reasoning results based on a corresponding set of relevant data that is associated with the node, and
including the subset of reasoning results in the first set of reasoning results.

6. The method of claim 1, wherein maintaining the relevance tree comprises:
associating a root node of the relevance tree with the reasoning task;
constructing a first node as a child node of the root node; and
associating the first node with the first set of relevant data.

7. The method of claim 6, wherein updating the relevance tree comprises
constructing a second node as a child node of the first node; and
associating the second node with the second set of relevant data.

8. The method of claim 1, wherein maintaining the relevance tree comprises:
storing a set of source relationships between the first set of relevant data and the set of semantic data in the relevance tree; and
storing a set of result relationships between the first set of relevant data and the first set of reasoning results in the relevance tree.

9. The method of claim 8, further comprising:
detecting, by the incremental reasoning system, a change made to a piece of data in the set of semantic data, wherein the piece of data is identified from the set of semantic data for affecting the relevance tree and the first set of reasoning results; and
updating, by the incremental reasoning system, the relevance tree and the first set of reasoning results that are affected by the change, wherein the incremental reasoning system is configured to generate a third set of reasoning results based on the updated relevant tree.

10. The method of claim 9, wherein updating the resolvable relevance tree and the first set of reasoning results comprises
identifying a first node in the relevance tree for having the source relationship with the piece of data;
upon a determination that the change is a modification or a deletion, removing the first node and its child nodes from the relevance tree; and
removing a subset of reasoning results from the first set of reasoning results, wherein the subset of reasoning results are identified for having result relationships with the first node and its child nodes.

11. The method of claim 10, wherein updating the resolvable relevance tree and the first set of reasoning results further comprises:
upon a determination that the change is a modification, adding a second node in replacement of the first node in the relevance tree, wherein the incremental reasoning system is configured to utilize the second node when generating the third set of reasoning results based on the updated relevant tree.

12. A method for performing a reasoning task based on a set of semantic data, the method comprising:
performing, by an incremental reasoning system, the reasoning task by incrementally
extracting a corresponding set of relevant data from the set of semantic data,
generating a corresponding set of reasoning results based on the corresponding set of relevant data, and
maintaining a relevance tree based on the corresponding set of relevant data, and
concurrent to the performing of the reasoning task, monitoring, by the incremental reasoning system, the set of semantic data for changes that may affect the corresponding set of reasoning results.

13. The method of claim 12, wherein extracting the corresponding set of relevant data comprises:
in a first iteration, extracting the corresponding set of relevant data from the set of semantic data for being relevant to the reasoning task; and
in a second iteration subsequent to the first iteration,
extracting the corresponding set of relevant data for the set of semantic data for being relevant to a leaf node of the relevance tree, and
updating the relevance tree based on the corresponding set of relevant data.

14. The method of claim 12, wherein maintaining the relevance tree comprises:
storing a set of source relationships between the corresponding set of relevant data and the set of semantic data in the relevance tree; and
storing a set of result relationships between the corresponding set of relevant data and the corresponding set of reasoning results in the relevance tree.

15. The method of claim 14, further comprising:
detecting a change made to a piece of data in the set of semantic data, wherein the piece of data is identified from the set of semantic data based on the set of source relationships; and
updating the relevance tree and the corresponding set of reasoning results that are affected by the change based on the set of result relationships.

16. A system for performing a reasoning task based on a set of semantic data, the system comprising:
a scalable data processing module configured to extract a first set of relevant data from the set of semantic data based on the reasoning task, and construct a relevance tree based on the first set of relevant data;
a reasoning module coupled with the scalable data processing module, wherein the reasoning module is configured to generate a first set of reasoning results by performing the reasoning task based on the first set of relevant data; and
a dynamical data processing module configured to operate concurrently along with the scalable data processing module to monitor the set of semantic data for changes that may affect the first set of reasoning results.

17. The system as recited in claim 16, wherein scalable data processing module is further configured to
extract the first set of relevant data based on the reasoning task in a first iteration, and
extract a second set of relevant data from the set of semantic data based on the relevance tree in a second iteration subsequent to the first iteration.

18. The system as recited in claim 17, wherein
the scalable data processing module is further configured to update the relevance tree based on the second set of relevant data, and
the reasoning module is further configured to generate a second set of reasoning results by performing the reasoning task based on the second set of relevant data.

19. The system as recited in claim 16, wherein the dynamical data processing module is further configured to
update the relevance tree and the first set of reasoning results upon a detection of a change in the set of semantic data that affects the first set of reasoning results.

20. A non-transitory machine-readable medium having a set of instructions which, when executed by a processor, cause the processor to perform a method for performing a reasoning task based on a set of semantic data, the method comprising:
extracting, by an incremental reasoning system, a first set of relevant data from the set of semantic data based on the reasoning task;
generating, by the incremental reasoning system, a first set of reasoning results by performing the reasoning task based on the first set of relevant data; and
maintaining, by the incremental reasoning system, a relevance tree based on the first set of relevant data, wherein the incremental reasoning system is configured to extract a second set of relevant data from the set of semantic data based on the relevance tree and generate a second set of reasoning results based on the second set of relevant data.
